(19) United States
(12) Patent Application Publication
(10) Pub. No.: US 2009/0078131 A1
(43) Pub. Date: Mar. 26, 2009

(54) FOOD PROCESSING DEVICE

(75) Inventors: Kwok Kuen So, Kowloon Tong (HK); Lance Logan Hood, Seattle, WA (US); Clive Koon Yin Wong, San Leandro, CA (US)

Correspondence Address: LEYDIG VOIT & MAYER, LTD, 700 THIRTEENTH ST. NW, SUITE 300, WASHINGTON, DC, 20005-3960, US

(73) Assignee: Kwok Kuen So, Hong Kong (CN)

(21) Appl. No.: 12/233,644

(22) Filed: Sep. 19, 2008

(30) Foreign Application Priority Data
Sep. 20, 2007 (EP) 07253728.5

(51) Int. Cl. B30B 7/00

(52) U.S. Cl. 100/234

(57) ABSTRACT

A food processing device has a handle holding a food receptacle, a cutter having perforations and extending across a bottom opening of the receptacle, and a presser extendable into the receptacle and movable towards the cutter for pressing food in the receptacle against the cutter, whereby the food is cut into smaller pieces. The presser has a press surface, which has a protruding pattern matching the perforations of the cutter for passing through the perforations to press food through the cutter.

The present invention relates to a food processing device which is, particularly but not exclusively, for mashing and cutting food.

### BACKGROUND OF THE INVENTION

Handheld food presses, mashers and cutters usually come in various different constructions or designs, and independently. Acquiring all these types does not only duplicate the cost but they also take up precious space especially at home.

A construction for one type of food processing devices may not fit another type. If a certain construction can be shared by more than one type for a majority of their parts/components, this will mean significant saving in cost, even at production level, for each type if not all. Multiple functions are a bonus.

The invention seeks to provide a new or otherwise improved food processing device, with the above considerations in mind.

### SUMMARY OF THE INVENTION

According to the invention, there is provided a food processing device comprising a handle, a receptacle supported by the handle for holding food, the receptacle having a lower opening, a cutter having perforations and extending across the bottom opening of the receptacle, and a presser extendable into the receptacle and movable towards the cutter for pressing food in the receptacle against the cutter, whereby said food is cut into smaller pieces. The presser has a press surface for food pressing, which surface has a protruding pattern matching the perforations of the cutter for passing through the perforations to press food in the receptacle through the cutter.

Preferably, the food processing device includes a lever pivotably connected relative to the handle, the lever supporting the presser.

More preferably, the presser is pivotably connected to the lever.

It is preferred that the cutter comprises a lattice of cutting blades arranged for cutting in a common cutting direction, along which direction the presser is movable towards the cutter.

In a preferred embodiment, the cutter is detachable from the receptacle.

More preferably, the receptacle comprises a cylindrical wall having a lower open end that acts as the bottom opening, and includes an annular retainer releasably connected to the bottom opening for attaching the cutter to the receptacle.

Further more preferably, the retainer has an internal flange for bearing upon the cutter to retain the cutter against the lower open end of the wall.

Further more preferably, the wall has a screw thread, and the retainer has a screw thread for engaging the screw thread of the wall, whereby the retainer is releasably connected to the wall.

In the preferred embodiment, the presser has a presser body and a press member thereon providing the press surface, the press member being detachable from the presser body.

More preferably, the presser body and the press member have inter-engageable formations for inter-engagement to attach the press member to the presser body.

Further more preferably, the formations comprise a groove in the presser body and a protrusion on the press member, the groove and the protrusion having complimentary cross-sections for inter-engagement upon sliding together in a direction laterally of the presser body and the press member.

In the preferred embodiment, the food processing device includes a perforated plate attachable to the receptacle as the cutter for replacing the cutter, and a press member having a generally flat press surface attachable to the presser body as the first-mentioned press member for replacing the first-mentioned press member, the flat press surface being movable towards the perforated plate for pressing food in the receptacle against or through the perforated plate.

It is preferred that the food processing device includes a hook on one side of the receptacle opposite the handle, for engaging upon a rim of a food vessel while the handle is resting upon the opposite side of said rim, whereby the food processing device is located on said food vessel.

In a preferred embodiment, the food processing device includes at least two said cutters which have different patterns of perforations and are interchangeably attachable to the bottom opening of the receptacle, wherein the presser includes a said press surface having a protruding pattern matching the perforations of each respective one of the cutters, the press surfaces being interchangeably usable.

More preferably, the food processing device further includes a perforated plate interchangeably attachable to the bottom opening of the receptacle, wherein the presser further includes a generally flat press surface interchangeably usable for pressing food in the receptacle against or through the perforated plate.

### BRIEF DESCRIPTION OF DRAWINGS

The invention will now be more particularly described, by way of example only, with reference to the accompanying drawings, in which:

FIG. 1 is a front perspective view of an embodiment of a food processing device in accordance with the invention;

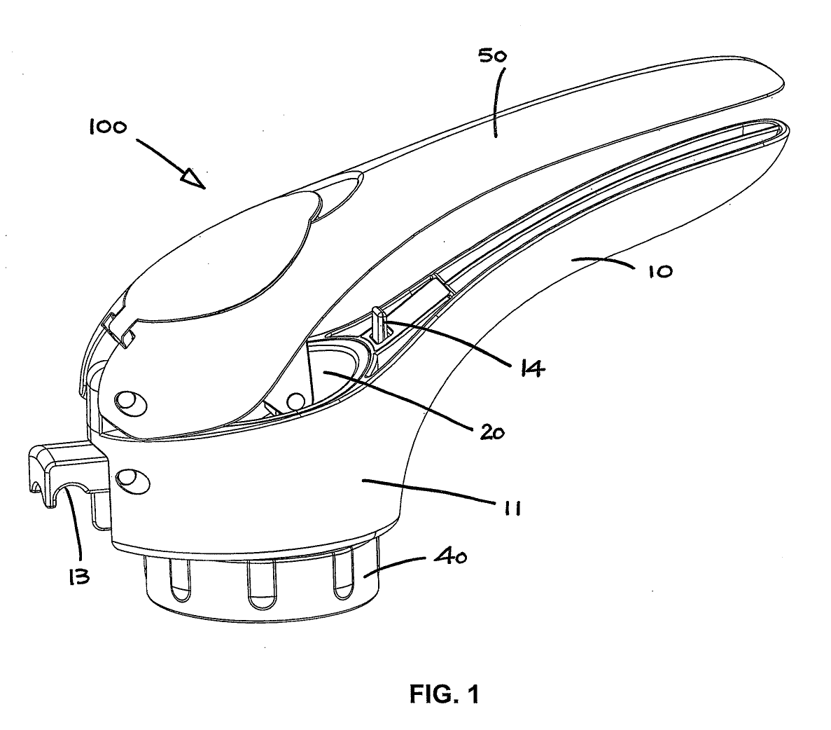

FIG. 2 is a rear perspective view of the food processing device of FIG. 1;

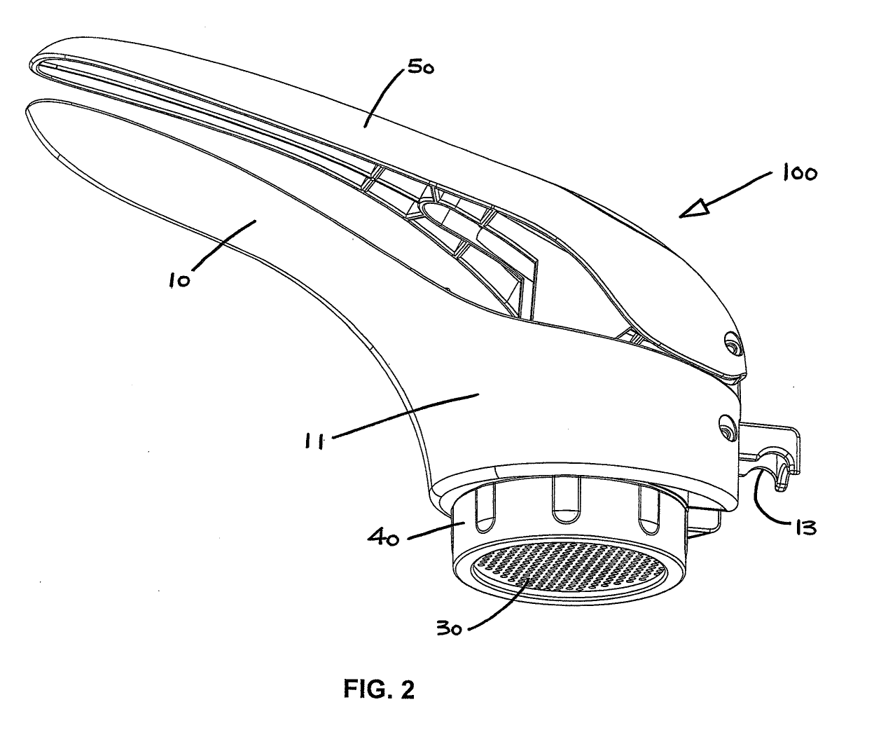

FIG. 3 is a bottom plan view of the food processing device of FIG. 1;

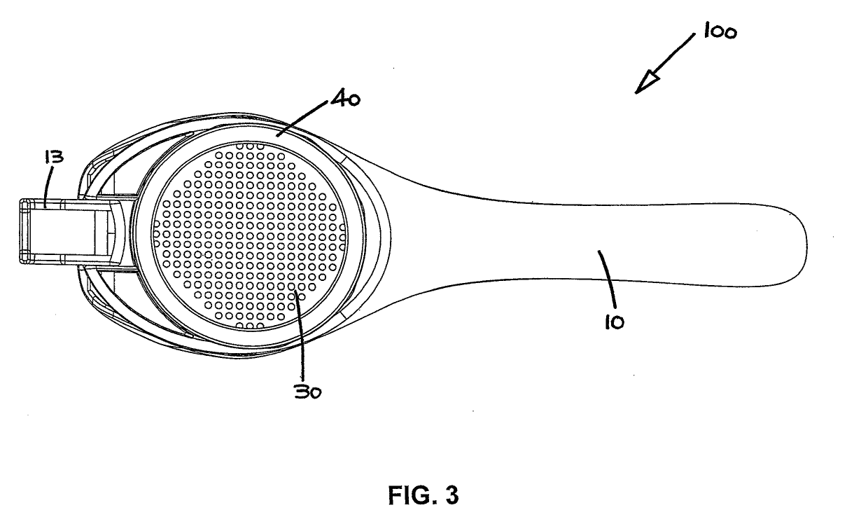

FIG. 4 is a perspective view of the food processing device of FIG. 1 in an open condition, showing a press head thereof partially detached;

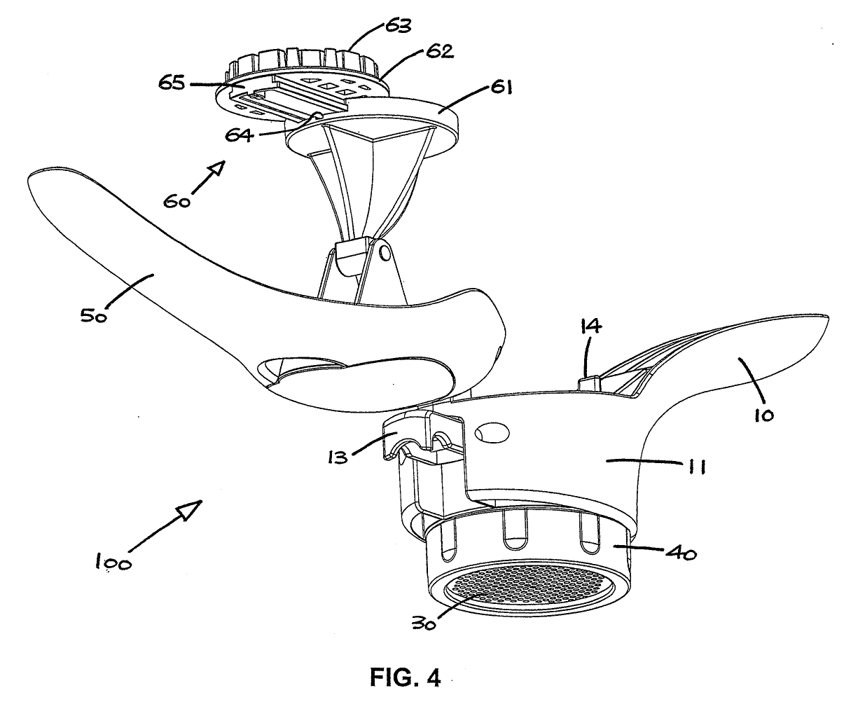

FIG. 5 is a perspective view of the food processing device of FIG. 4 (with specific details being slightly different), showing certain components separated;

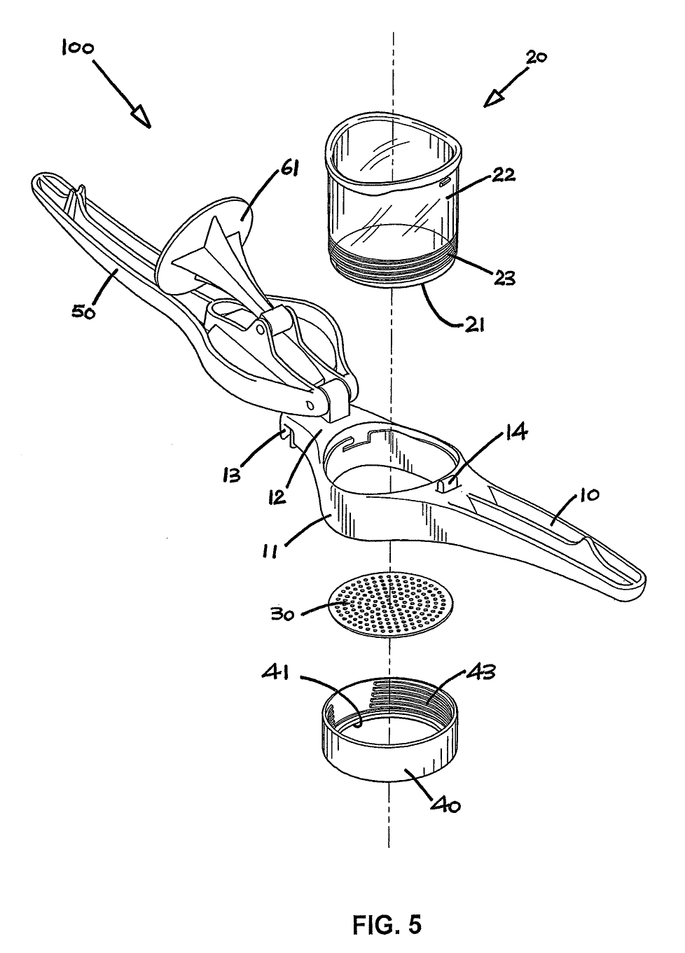

FIG. 6 is a perspective view similar to FIG. 4, showing the press head detached and two additional press heads for interchangeable use;

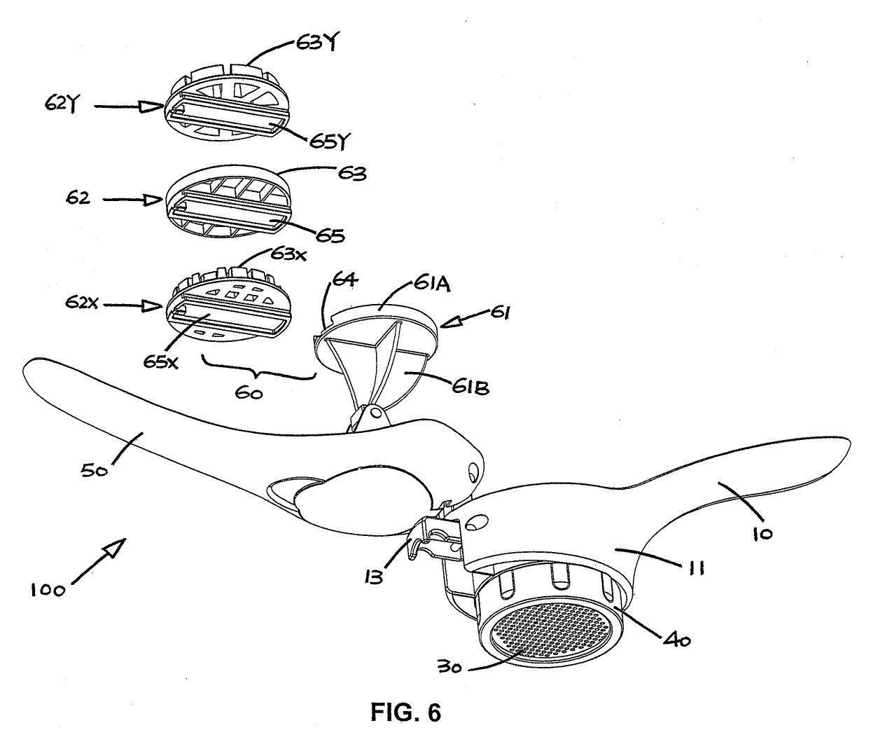

FIG. 7 is a bottom plan view of the food processing device of FIG. 6, using one interchangeable press head and a co-operating cutter; and

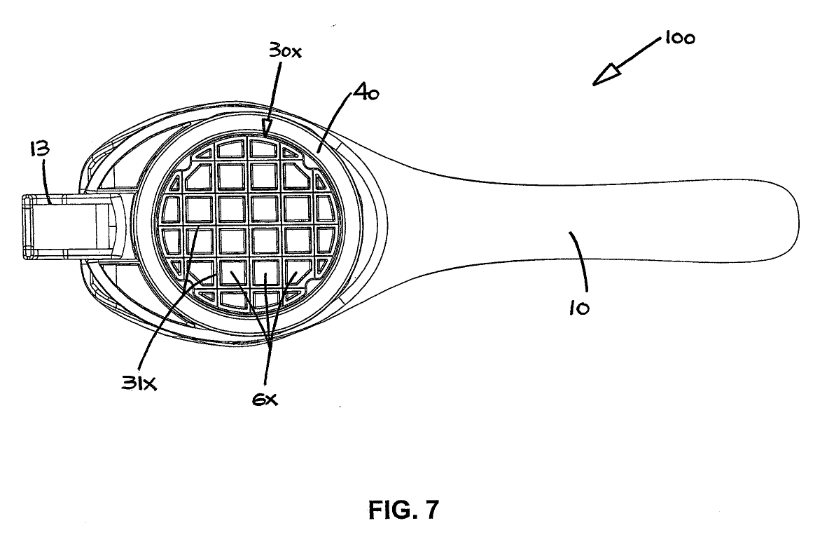

FIG. 8 is a bottom plan view of the food processing device of FIG. 6, using the other interchangeable press head and a co-operating cutter.

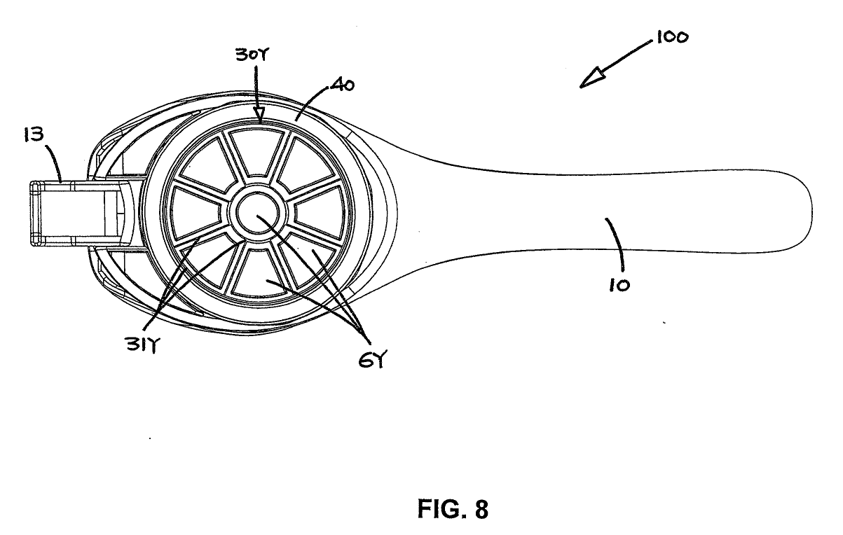

### DETAILED DESCRIPTION OF PREFERRED EMBODIMENT

Referring to the drawings, there is shown a food processing device 100 embodying the invention, which may be used as a food masher for mashing potatoes, pumpkins, butternuts or the like, or as a food presser for pressing garlic or lemons, etc., or as a food cutter/slicer for cutting vegetables and fruits such as potatoes, carrots, apples and pears or even boiled eggs.

While acting as a food masher 100, the device has an elongate handle 10, a cylindrical receptacle 20 supported by the handle 10, and a perforated disc 30 which extends across and closes a lower open end or bottom opening 21 of the receptacle 20 and through which food items, such as cubes of baked potato, in the receptacle 20 are to be mashed through the disc 30. Front end portion of the handle 10 is expanded to form a generally cylindrical collar 11, into which the receptacle 20 is received and suspended by its thickened upper rim. The receptacle 20 is locked in position by a spring-loaded latch 14 in the handle 10.

The receptacle 20 includes a cylindrical wall 22 having an external screw thread 23 around its bottom end 21. A retainer ring 40, which has an internal screw thread 43 designed for engagement with the external screw thread 23, is releasably connected upon screwing onto the bottom end 21 for attaching the perforated disc 30 to the receptacle 20.

The retainer ring 40 has an internal flange 41 and is just sufficiently large to hold the perforated disc 30 therein on the flange 41, with the flange 41 bearing upon the disc 30 and retaining the disc 30 against the bottom end 21 of the wall 22. The retainer ring 40 may be unscrewed for detaching the disc 30 from the receptacle 20.

The food masher 100 includes an upper lever 50 which is pivotably connected at one end to a frontmost end 12 of the handle 10 below, at a position on and adjacent one side (i.e. front side) of the handle collar 11 opposite the main body of the handle 10. A presser 60 is pivotably connected to a front end portion of the lever 50 for support thereby and, in operation, extending downwardly into the receptacle 20 as the lever 50 is pivoted down close to the handle 10. The presser 60 will then slide axially along the receptacle 20 like a piston, towards the perforated disc 30 for pressing potato cubes in the receptacle 20 against the disc 30, whereby the potato cubes are mashed through the perforations of the disc 30, which acts as a masher.

The frontmost end 12 of the handle 10 terminates as a hook 13 which faces downwards for engaging upon a rim of a food vessel while the handle 10 is resting upon the opposite side of the vessel's rim, whereby the food masher 100 may conveniently be located on the food vessel, into which the mashed potato can drop. The hook 13, when not in use, can be folded into a recess of the handle collar 11.

The presser 60 has a presser body 61 in the form of a circular disc 61A and an integral stem 61B extending therefrom and hinged to the lever 50, and includes a disc-like press head 62 on the disc 61A, which provides a generally flat outer press surface 63 for food pressing. The disc 61A and the press head 62 have respective inter-engageable formations 64 and 65 for inter-engagement to releasably attach the press head 62 to the presser body 61.

The aforesaid formations, more specifically, comprise a flat groove 64 which extends across the disc 61A of the presser body 61 and a flat protrusion 65 which extends across the press head 62. The groove 64 and the protrusion 65 have complimentary flat T-shaped cross-sections for inter-engagement upon sliding together as in a dovetail joint, in a direction laterally of the presser body 61 and head 62. The press head 62 may be detached from the presser body 61, upon sliding in the opposite direction.

With its flat press surface 63, the press head 62 is co-operable with the perforated disc 30 to extract juice by pressing food in the receptacle 20 against the perforated disc 30 or to prepare mashed food by pressing food in the receptacle 20 through the perforated disc 30.

These two components 62 and 30 are detachable as described above, and they may be replaced by a set of equivalent components, i.e. a different press head 62X and a disc-like cutter 30X, for cutting/slicing food.

The cutter 30X comprises a lattice of cutting blades 31X formed by two groups of evenly-spaced cutting blades 31X which intercept at right angles with each other to define an array of square perforations noticeably over the central region. The cutter 30X has the same outer diameter as the previous perforated disc 30 to fit inside the retainer ring 40, which may be screwed onto the receptacle 20 to a lesser extent to accommodate the relatively thicker cutter 30X.

The cutting blades 31X are arranged for cutting in a common cutting direction axially of the receptacle 20, along which direction the press head 62X (of the presser 60) is slidable towards the cutter 30X. The blades 31X extend lengthwise at an angle (i.e. 90°) relative to each other and widthwise in the same direction for cutting.

The press head 62X has generally the shape and size as the previous press head 62, including an identical flat T-sectioned protrusion 65X for a dovetail-like joint with the groove 64 of the presser body 61. Its press surface 63X is however different. The press surface 63X is not solid flat but having a protruding pattern of evenly spaced square press knobs 6X noticeably over the central region, which match the perforations of the cutter 30X, albeit slightly smaller. The knobs 6X project outwards to a greater extent than the thickness of the cutter 30X such that they can and are arranged, in operation, to go right through the cutter's perforations for pressing food in the receptacle 20 completely through the cutter 30X, thereby cutting/slicing the food into smaller pieces i.e. strips.

There is another set of interchangeable components for food cutting i.e. press head 62Y and lattice cutter 30Y, which are very similar to the previous press head 62X and cutter 30X, with equivalent parts designated by the same reference numerals suffixed by a letter “Y” instead of “X”. The only difference lies in the arrangement of the cutting blades 31Y and hence the shape of the matching press knobs 6Y.

The cutting blades 31Y are arranged in two concentric rings interconnected by eight equiangularly-spaced radial lines, together defining eight trapezium-like perforations and a circular perforation at the centre, that being the shapes of the co-operating press knobs 6Y, albeit slightly smaller.

In the preferred embodiment, the food processing device 100 incorporates at least two cutters 30X and 30Y (of different cutting/slicing patterns) with matching press heads 62X and 62Y (of correspondingly different press patterns) for alternative use, in addition to the masher disc 30 with flat press head 62 as a further option.

Through selective interchangeable use of the cutters 30X/30Y and masher 30 with press heads 62X/62Y/62, the food processing device 100 offers multiple functions in a single tool. This is convenient to use and also represents substantial saving in storage space and production at the outset.

It should be appreciated that modifications and alterations obvious to those skilled in the art are not to be considered as beyond the scope of the present invention. For example, although their press surfaces 63X/63Y have protruding knobs, the press head 62X/62Y may be used in conjunction with the perforated disc 30 for mashing food or extracting juice.

1. A food processing device comprising:
a handle;
a receptacle supported by the handle for holding food, the receptacle having a bottom opening;
a cutter having perforations and extending across the bottom opening of the receptacle; and
a presser extendable into the receptacle and movable towards the cutter for pressing food in the receptacle against the cutter, whereby the food is cut into smaller pieces, wherein the presser has a press surface for food pressing, and the press surface has a protruding pattern matching the perforations of the cutter for passing through the perforations to press food in the receptacle through the cutter.

2. The food processing device as claimed in claim 1, including a lever pivotably connected relative to the handle, the lever supporting the presser.

3. The food processing device as claimed in claim 2, wherein the presser is pivotably connected to the lever.

4. The food processing device as claimed in claim 1, wherein the cutter comprises a lattice of cutting blades arranged for cutting in a common cutting direction, along which direction the presser is movable towards the cutter.

5. The food processing device as claimed in claim 1, wherein the cutter is detachable from the receptacle.

6. The food processing device as claimed in claim 5, wherein the receptacle comprises a cylindrical wall having a lower open end as the bottom opening, and includes an annular retainer releasably connected to the bottom opening for attaching the cutter to the receptacle.

7. The food processing device as claimed in claim 6, wherein the retainer has an internal flange for bearing upon the cutter to retain the cutter against the lower open end of the wall.

8. The food processing device as claimed in claim 6, wherein the wall has a screw thread, and the retainer has a screw thread for engaging the screw thread of the wall, whereby the retainer is releasably connected to the wall.

9. The food processing device as claimed in claim 5, wherein the presser has a presser body and a first press member on the presser body and including the press surface, the first press member being detachable from the presser body.

10. The food processing device as claimed in claim 9, wherein the presser body and the first press member have inter-engageable formations for inter-engagement to attach the first press member to the presser body.

11. The food processing device as claimed in claim 10, wherein the formations comprise a groove in the presser body and a protrusion on the first press member, the groove and the protrusion having complementary cross-sections for inter-engagement upon sliding together in a direction lateral to the presser body and the first press member.

12. The food processing device as claimed in claim 9, including a perforated plate attachable to the receptacle as the cutter, and a second press member having a generally flat press surface and attachable to the presser body in place of the first press member, the flat press surface being movable towards the perforated plate for pressing food in the receptacle against and through the perforated plate.

13. The food processing device as claimed in claim 1, including a hook on one side of the receptacles opposite the handle, for engaging a rim of a food vessel while the handle is resting upon an opposite side of the rim, whereby the food processing device is located on the food vessel.

14. The food processing device as claimed in claim 1, including at least two cutters which have different patterns of perforations and are interchangeably attachable to the bottom opening of the receptacle, and the presser includes two interchangeable press surfaces having a respective protruding patterns respectively matching the perforations of the two cutters.

15. The food processing device as claimed in claim 14, further including a perforated plate interchangeably attachable to the bottom opening of the receptacle, wherein one of the press surfaces further includes a generally flat press surface for pressing food in the receptacle against and through the perforated plate.
